(19) United States
(12) Patent Application Publication
(10) Pub. No.: US 2010/0030265 A1
(43) Pub. Date: Feb. 4, 2010

(54) COMBINATION PACIFIER TETHERING AND BRACELET SYSTEMS AND RELATED METHODS

(76) Inventor: Rhett Templeton Ambrite, Charleston, SC (US)

Correspondence Address: Law Offices of Bentley J. Olive, PLLC, 130 Edinburgh Dive South,, Suite 107, Cary, NC, 27511, US

(21) Appl. No.: 12/185,781

(22) Filed: Aug. 4, 2008

(51) Int. Cl. A61J 17/00; A44C 5/00; A44C 25/00

(52) U.S. Cl. 606/236; 606/234; 63/3.1; 63/33

(57) ABSTRACT

Combination pacifier tethering and bracelet systems and related methods are disclosed. According to an aspect of the disclosed subject matter, a system comprises a flexible stringing component including first and second ends. The system also comprises first and second clip mechanisms attached to the first and second ends, respectively, of the stringing component. The first and second clip mechanisms are adapted for coupling together in a bracelet mode such that the stringing component substantially forms a loop. In a pacifier tethering mode, the first clip mechanism is adapted for coupling to a pacifier, and the second clip mechanism is adapted for coupling to an anchor for tethering the pacifier to the anchor.

### TECHNICAL FIELD

The subject matter described herein relates to infant and toddler products. Particularly, the subject matter described herein relates to combination pacifier tethering and bracelet systems and related methods.

### BACKGROUND

Pacifiers are commonly used by infants and toddlers for providing soothing comfort when tired or agitated. One difficulty with pacifiers is that they are often dropped, and, as a result, they touch a contaminated surface such as the ground. This is undesirable because the pacifier must then be cleaned before use by the infant or toddler. Often, the pacifier is dropped at a location where cleaning is inconvenient or not readily possible.

Systems have been developed for securing a pacifier to prevent it from contacting a contaminated surface. For example, a pacifier may be tethered to an article of clothing worn by the infant or child using the pacifier. By tethering the pacifier to clothing, the pacifier can be prevented from touching the ground if it is dropped by the infant or child. When the pacifier is dropped, it can only go as far as permitted by the tether, which is of a distance to prevent it from reaching the ground.

Decorative pacifier tethering systems have been produced that also function as jewelry. These tethers include a wire decorated with a plurality of decorative beads. A clip mechanism is attached to one end of the wire for attachment to clothing. A loop is formed by attaching the tether back to itself for coupling to a pacifier.

One disadvantage of existing pacifier tethering systems is that they do not also provide the function of serving as an aesthetically-pleasing jewelry bracelet. Such a combination system would be beneficial because it could provide additional functionality.

### SUMMARY

It is an object of the presently disclosed subject matter to provide combination pacifier tethering and bracelet systems and related methods.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

According to an aspect of the subject disclosed herein, a combination pacifier tethering and bracelet system comprises a flexible stringing component including first and second ends. The system also comprises first and second clip mechanisms attached to the first and second ends, respectively, of the stringing component. The first and second clip mechanisms are adapted for coupling together in a bracelet mode such that the stringing component substantially forms a loop. In a pacifier tethering mode, the first clip mechanism is adapted for coupling to a pacifier, and the second clip mechanism is adapted for coupling to an anchor for tethering the pacifier to the anchor.

According to another aspect of the subject matter disclosed herein, a method of producing a combination pacifier tethering and bracelet system comprises providing a flexible stringing component including first and second ends. The method also includes attaching first and second clip mechanisms to the first and second ends, respectively, of the stringing component, the first and second clip mechanisms being adapted for coupling together in a bracelet mode such that the stringing component substantially forms a loop, and, in a pacifier tethering mode, the first clip mechanism being adapted for coupling to a pacifier, and the second clip mechanism being adapted for coupling to an anchor for tethering the pacifier to the anchor.

### BRIEF DESCRIPTION OF THE DRAWINGS

The subject matter described herein will now be explained with reference to the accompanying drawings of which:

FIG. 1 is a top view of a combination pacifier tethering and bracelet system according to an embodiment of the subject matter described herein;

FIG. 2 is a perspective view of a system in a pacifier tethering mode according to an embodiment of the subject matter described herein;

FIG. 3 is a perspective view of a system in a bracelet mode according to an embodiment of the subject matter described herein; and

FIG. 4 is a flow chart of an exemplary process of producing a combination pacifier tethering and bracelet system in accordance with an embodiment of the subject matter described herein.

### DETAILED DESCRIPTION

Combination pacifier tethering and bracelet systems and related methods are described herein. A combination pacifier tethering and bracelet system in accordance with the subject matter described herein may comprise a flexible stringing component including first and second ends. The system may also comprise first and second clip mechanisms attached to the first and second ends, respectively, of the stringing component. The first and second clip mechanisms may be adapted for coupling together in a bracelet mode such that the stringing component substantially forms a loop. The looped stringing component can form a bracelet for wear around an adult's wrist thus creating an heirloom keepsake for the infant. In a pacifier tethering mode, the first clip mechanism may be adapted for coupling to a pacifier, and the second clip mechanism may be adapted for coupling to an anchor for tethering the pacifier to the anchor. The anchor can be an article of clothing worn by the infant or toddler.

As referred to herein, the term “bead” is any physical member including a passage or orifice defined therein. The term “bead” may include not only spherical members, but also any other suitable three-dimensional member including a passage there through. Exemplary beads may include letter beads, sport beads, and shaped theme beads such as beads representing airplanes, religious symbols, rabbits, and the like.

As referred to herein, the term “flexible stringing component” is any physical member being flexible and string-like. For example, the stringing component can be a wire beaded with a plurality of beads.

As referred to herein, the term “clip mechanism” is any physical member capable of coupling itself to another physical member. For example, a clip mechanism may include a jaw body and a spring arm. In this example, the spring arm can be rotatably coupled to the jaw body and resistively coupled to an arm of the jaw body. The clip mechanism can include a portion forming an orifice or hole onto which an end of a flexible stringing component can be attached.

The subject matter described herein provides a combination system for tethering a pacifier to an anchor, such as infant or child's clothing, and for functioning as a bracelet. The system can function in two modes of operation: in a bracelet mode for wear around a young adult or older adult's wrist or ankle; and in a pacifier tethering mode for attachment at one end to a pacifier and for coupling at an opposing end to an anchor for tethering the attached pacifier to the anchor. Therefore, the system may function as a tether or retainer for a pacifier. During the time the child uses a pacifier or after the child outgrows the pacifier, the system may also function as a bracelet. Thus, the system provides the dual functions of serving as a pacifier tethering and a bracelet.

Further, the systems described herein are attractive and safe. The system may include beads of a desired decorative design. The system may include a metal wire and other components for providing a robust and durable design. In one example, the metal wire can be a nylon-coated, stainless steel wire.

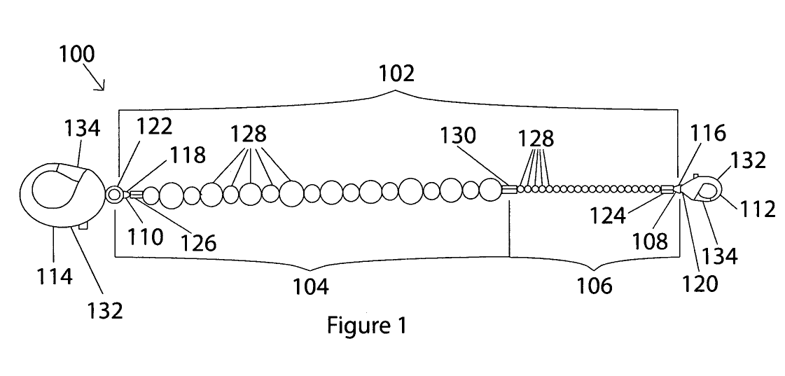

FIG. 1 illustrates a top view of a combination pacifier tethering and bracelet system, generally designated 100, according to an embodiment of the subject matter described herein. Referring to FIG. 1, system 100 comprises a flexible stringing component, generally designated 102. Stringing component 102 includes first and second portions, generally designated 104 and 106, connected to one another at an end of each. In addition, stringing component includes first and second ends 108 and 110 attached to first and second clip mechanisms 112 and 114, respectively, such that the first and second clip mechanisms are securely connected to one another via the stringing component.

Flexible stringing component 102 can include a stringing wire that extends between first and second ends 108 and 110. The stringing wire can form loops 116 and 118 at ends 108 and 110, respectively, for attachment to clip mechanisms 112 and 114, respectively. Loops 116 and 118 may be formed by passing the ends of the stringing wire through coupling orifices 120 and 122, respectively, of clip mechanisms 112 and 114, respectively, and back upon one another to form the loops. Once the wire ends are formed back upon one another, the loops may be secured by crimp beads 124 and 126 or other securing device. Alternatively, the ends of the stringing wire may be attached to the clip mechanisms by any number of attachment means including, but not limited to, an adhesive, a tying of the stringing wire around the coupling orifices, a mechanical fastener, and the like. In one example, the stringing wire ends may be attached to the clip mechanisms by double-crimping a crimp bead.

The stringing wire may be constructed of any number of suitable materials including polymers, fibrous strings, and the like. In one example, the stringing wire can be a plurality of stainless steel strands coated in a polymer such as nylon. In one example, the stringing wire can be a 49-strand, stainless steel, nylon-coated, and 36 lb. test wire.

A plurality of beads, only a few of which are designated by reference numeral 128, can be positioned on the stringing wire between ends 108 and 110. In particular, the beads can be beaded on the stringing wire prior to forming one or both of loops 116 and 118. The beads can be decorative and of any suitable size. In this example, the beads at first portion 104 are generally sized larger than the beads at second portion 106.

A crimp bead 130 can be attached to the stringing wire for separating the beads at portions 104 and 106. The crimp bead is positioned there in order to clasp it properly due to the size of the opening of the clip mechanism and the size of the beads.

Clip mechanisms 112 and 114 can each include a large jaw body 132 that curves upon itself. Additionally, a spring arm 134 is rotatably coupled to the base of jaw body 200 and resistively coupled to the extending arm of the jaw body. As described further herein, clip mechanism 112 can clip onto first portion 106 for attaching to a pacifier. Clip mechanism 114 can squeeze a desired section of an infant's clothing between two planar members for attachment to the clothing. In this example, the clip mechanisms are made of stainless steel. Alternatively, the clip mechanisms can be made of any number of non-corrosive alloys, plastics, and the like. Once attached to a pacifier at one end and attached to an infant's clothing at the opposing end, the system can prevent the pacifier from dropping to the ground and thus potentially contaminating the pacifier.

Clip mechanisms 112 and 114 have lengths of about 0.4 inches and 1 inch, respectively. Alternatively, the length of clip mechanism 112 can range between about 0.4 inches and about 3 inches. Alternatively, the length of clip mechanism 114 can range between about 0.5 inches and about 3 inches.

In the example of the system shown in FIG. 1, the distance between the first and second clip mechanisms when the stringing component is extended in a line is about seven inches. Alternatively, the distance between the clip mechanisms can be between about 6 inches and about 8 inches.

Further, in the example of the system shown in FIG. 1, the length of first portions 104 and 106 of the stringing component is about five inches and two inches, respectively. Alternatively, the lengths of the first and second portions can be between about 4-6 inches and 2-4 inches, respectively.

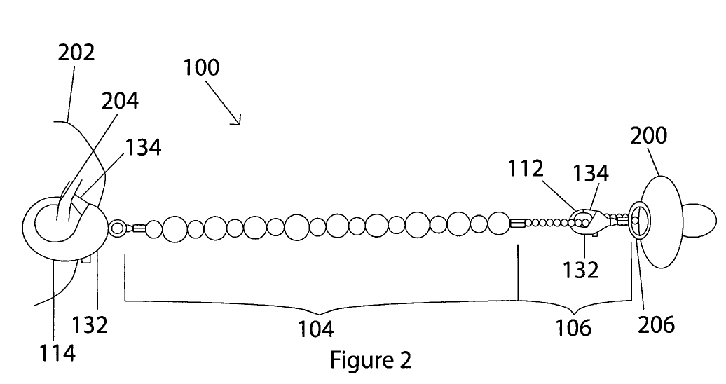

FIG. 2 illustrates a perspective view of system 100 in a pacifier tethering mode according to an embodiment of the subject matter described herein. Referring to FIG. 2, clip mechanisms 112 and 114 are coupled to a pacifier 200 and a portion of infant's clothing 202, respectively, for tethering the pacifier to the clothing. Clothing 202 is an anchor secure tethering of pacifier 200. By tethering pacifier 200 to the anchor, pacifier 200 is prevented from touching the ground and potentially contaminating the pacifier if the pacifier is dropped by the infant. A sleeve or another portion of the infant's clothing can be disposed between spring arm 134 and a flat face section 204 of jaw body 114. The pressure provided by jaw body 114 securely fastens system 100 to the clothing.

Clip mechanism 112 can be coupled to pacifier 200 by looping clip mechanism 112 through an orifice formed by a ring portion 206 of pacifier 200 and back to first portion 106 of the stringing component where clip mechanism 112 is attached to the first portion. First portion 106 can be held within a hole formed by jaw body 132 and spring arm 134.

Alternatively, clip mechanism 112 can be coupled to pacifier 200 by any other suitable technique, such as by directly clipping clip mechanism 112 to the pacifier. For example, clip mechanism 112 can be directly clipped to a ring portion 206 of the pacifier.

In another example of tethering a pacifier, clip mechanism 114 may be directly clipped to ring portion 206 of pacifier. Clip mechanism 112 may be attached to clothing or another anchor. This configuration may be useful if clip mechanism 112 is not large enough to attach to a particular pacifier.

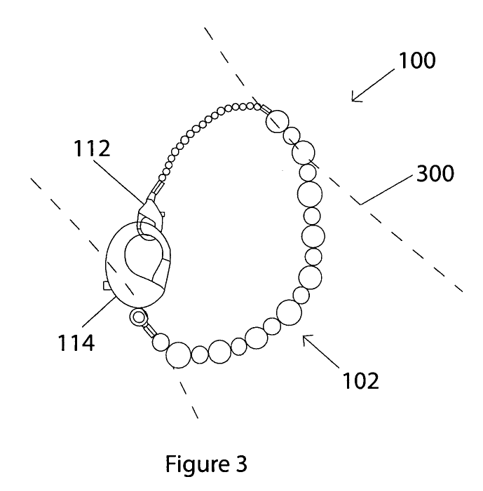

FIG. 3 illustrates a perspective view of system 100 in a bracelet mode according to an embodiment of the subject matter described herein. Referring to FIG. 3, clip mechanisms 112 and 114 are coupled together such that the stringing component 102 forms a loop. The bracelet formed by system 100 can be worn around a person's wrist 300 (shown by broken lines).

Thus, as shown in FIGS. 2 and 3, the system described herein can provide the exemplary advantage of functioning as a tether for a pacifier in the pacifier tethering mode shown in FIG. 2, and of functioning as a bracelet in the bracelet mode shown in FIG. 3. As a result, the system can be used as either a bracelet or a pacifier tether when an infant is using a pacifier. Later, when the infant has outgrown the pacifier, the system may still provide use as a bracelet. In either mode, the system can be decorated with beads as described herein for also being aesthetically appealing as jewelry.

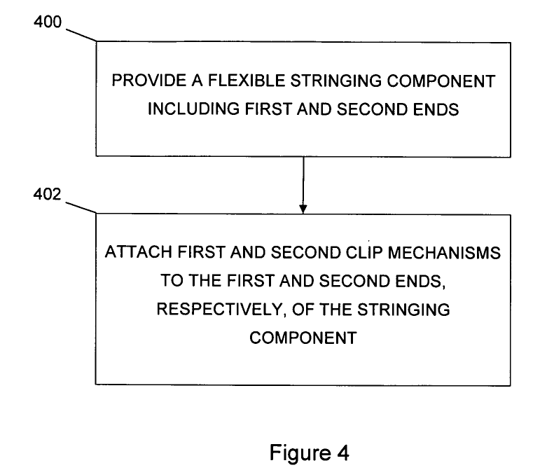

FIG. 4 is a flow chart illustrating an exemplary process of producing a combination pacifier tethering and bracelet system in accordance with an embodiment of the subject matter described herein. In this example, system 100 shown in FIGS. 1-3 is the system resulting from the steps of the process. Referring to FIGS. 1-4, the method can include a step of providing a flexible stringing component including first and second ends (block 400). For example, flexible stringing component 102 can be provided.

In block 402, first and second clip mechanisms can be attached to the first and second ends, respectively, of the stringing component. For example, clip mechanisms 112 and 114 can be attached to first and second ends 108 and 110, respectively, of stringing component 102. Prior to attaching the clip mechanisms, beads 128 can be beaded onto a wire of the stringing component.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A combination pacifier tethering and bracelet system comprising:
a flexible stringing component including first and second ends; and
first and second clip mechanisms attached to the first and second ends, respectively, of the stringing component, the first and second clip mechanisms being adapted for coupling together in a bracelet mode such that the stringing component substantially forms a loop, and
in a pacifier tethering mode, the first clip mechanism being adapted for coupling to a pacifier, and the second clip mechanism being adapted for coupling to an anchor for tethering the pacifier to the anchor.

2. The combination pacifier tethering and bracelet system of claim 1 wherein the flexible stringing component comprises a metal.

3. The combination pacifier tethering and bracelet system of claim 2 wherein the metal comprises stainless steel.

4. The combination pacifier tethering and bracelet system of claim 1 wherein the flexible stringing component is coated by a polymer.

5. The combination pacifier tethering and bracelet system of claim 4 wherein the polymer comprises nylon.

6. The combination pacifier tethering and bracelet system of claim 1 wherein the flexible stringing component comprises a metal string having first and second portions, wherein the first portion is beaded with a plurality of decorative beads of a first size, and wherein the second portion is beaded with a plurality of decorative beads of a second size, wherein the second size is greater than the first size.

7. The combination pacifier tethering and bracelet system of claim 6 wherein the first and second portions are at opposing ends of the stringing component.

8. The combination pacifier tethering and bracelet system of claim 7 wherein the first clip mechanism is attached to the first portion of the metal string, and wherein the second clip mechanism is attached to the second portion of the metal string.

9. The combination pacifier tethering and bracelet system of claim 1 wherein the first and second clip mechanisms each comprise:
a curved jaw body comprising a base and forming a concave overhang with a surface;
a coupling orifice formed in the base of the curved jaw body; and
a spring arm rotatably coupled to the base of the curved jaw body, wherein the spring arm is resistively coupled to the surface of the curved jaw body.

10. The combination pacifier tethering and bracelet system of claim 1 wherein the second clip mechanism is larger than the first clip mechanism.

11. The combination pacifier tethering and bracelet system of claim 1 wherein the first clip mechanism has a length of between about 0.4 inches and about 3 inches.

12. The combination pacifier tethering and bracelet system of claim 1 wherein the second clip mechanism has a length of between about 0.5 inches and about 3 inches.

13. The combination pacifier tethering and bracelet system of claim 1 comprising a plurality of decorative beads beaded to the flexible stringing component.

14. The combination pacifier tethering and bracelet system of claim 1 comprising a pacifier releasably attached to the first clip mechanism.

15. A method of producing a combination pacifier tethering and bracelet system, the method comprising:
providing a flexible stringing component including first and second ends; and
attaching first and second clip mechanisms to the first and second ends, respectively, of the stringing component, the first and second clip mechanisms being adapted for coupling together in a bracelet mode such that the stringing component substantially forms a loop, and, in a pacifier tethering mode, the first clip mechanism being adapted for coupling to a pacifier, and the second clip mechanism being adapted for coupling to an anchor for tethering the pacifier to the anchor.

16. The method of claim 15 wherein providing a flexible stringing component comprises providing the flexible stringing component comprising a metal string having first and second portions, wherein the first portion is beaded with a plurality of decorative beads of a first size, and wherein the second portion is beaded with a plurality of decorative beads of a second size, wherein the second size is greater than the first size.

17. The method of claim 16 comprising:
attaching the first clip mechanism to the first portion of the metal string; and
attaching the second clip mechanism to the second portion of the metal string.

18. The method of claim 15 wherein the first and second clip mechanisms each comprise:
a curved jaw body comprising a base and forming a concave overhang with a surface;
a coupling orifice formed in the base of the curved jaw body; and
a spring arm rotatably coupled to the base of the curved jaw body, wherein the spring arm is resistively coupled to the surface of the curved jaw body.

19. The method of claim 15 comprising beading a plurality of decorative beads to the flexible stringing component.

20. The method of claim 15 comprising releasably attaching a pacifier to the first clip mechanism.
